(19) United States
(12) Patent Application Publication
(10) Pub. No.: US 2022/0245606 A1
(43) Pub. Date: Aug. 4, 2022

(54) ELECTRONIC SYSTEM FOR ADAPTIVE DYNAMIC MULTI-DIRECTIONAL RESOURCE TRANSMISSIONS

(71) Applicant: BANK OF AMERICA CORPORATION, Charlotte, NC (US)

(72) Inventors: Sandeep Kumar Chauhan, Miyapur Hyderabad (IN); Joseph Benjamin Castinado, North Glenn, CO (US); Kapil Chhibber, Davis, CA (US); Naoll Addisu Merdassa, Chakopee, MN (US); Ann Ta, Scottsdale, AZ (US); Kathleen Hanko Trombley, Oakboro, NC (US)

(73) Assignee: BANK OF AMERICA CORPORATION, Charlotte, NC (US)

(21) Appl. No.: 17/163,262

(22) Filed: Jan. 29, 2021

(51) Int. Cl. G06Q 20/10; H04L 29/06; G06Q 20/02; G06Q 20/40; G06Q 20/32; G06Q 20/42; G05B 19/042

(52) U.S. Cl. CPC G06Q 20/108; H04L 63/08; G06Q 20/02; G06Q 20/4037; G06Q 20/326; G06Q 40/02; G06Q 20/40155; G06Q 20/42; G05B 19/0423; G06Q 20/3223; G06Q 20/3224

(57) ABSTRACT

Embodiments of the invention are directed to systems, methods, and computer program products for adaptive dynamic multi-directional resource transmissions. The invention is structured for dynamically authenticating an activity between network devices, identifying resource deficiencies associated with network devices, and deploying adapted mitigation resources at one or more network devices in real-time, and without requiring discontinuation of the activity. Specifically, the invention is structured to determine a first resource deficiency associated with the first resource. In response, the system is structured to transmit a first adapted mitigation resource of the one or more adapted mitigation resources to the first resource in a transmission direction, triggering transmission of a first resource quantity from the first resource to an entity resource on another transmission direction.

### FIELD

The invention is described herein is directed to systems, methods and computer program products for dynamically authenticating an activity between network devices, and identifying and mitigating resource deficiencies associated with network devices. In some aspects, the invention is structured for implementing adapted mitigation resources at one or more network devices in real-time, and without requiring discontinuation of the activity.

### BACKGROUND

Networked devices, such as computer terminals, are commonly used by individuals to perform a variety of activities. An activity may be initiated by a networked device. Typically, certain electronic activities require a chain of transmissions, e.g., a first transmission from an originating first networked device to an authorizing second networked device, and a subsequent second transmission from the second networked device to a processing recipient system. However, in conventional systems, once initiated, the activity, specifically parameters of the transmitted activity data, cannot be modified, for example, in the instances where a resource deficiency has been identified after initiation of the activity. Any alteration, if at all possible, requires abandoning the existing activity and initiating yet another activity from the beginning with new parameters. This requires increased processing capacity and may be detrimental to communication speeds due to the large number of activities initiated. This results in increased processing delays, and squandered processing resources. Moreover, conventional systems lack the ability to mitigate resource deficiencies associated with network devices. A need exists for systems and methods for improving the functionality and processing capability of networked devices for dynamically performing activities.

The present invention addresses the foregoing needs and also provides improvement to technology by improving the functionality of and processing capability of networked devices, by configuring the networked devices for proactive combination of temporal resource activity data and dynamic transmission of resources.

### BRIEF SUMMARY

Some embodiments of the invention are directed to systems, apparatuses, methods and computer program products for adaptive dynamic multi-directional resource transmissions. Specifically, the systems, apparatuses, methods and computer program products of the present invention are structured dynamically authenticating an activity between network devices, identifying resource deficiencies associated with network devices, and deploying adapted mitigation resources at one or more network devices in real-time, and without requiring discontinuation of the activity. In some embodiments the apparatuses and systems comprise at least one memory device, at least one communication device connected to a distributed network and at least one processing device operatively coupled to the at least one memory device at least one memory. The apparatuses and systems further comprise a module stored in the at least one memory device comprising executable instructions that when executed by the at least one processing device, cause the at least one processing device to: receive, from a first networked device associated with a first entity, resource activity processing data associated with a first activity initiated at the first networked device by a user; analyze the resource activity processing data to determine a first resource quantity to be transmitted in a first transmission direction from a first resource associated with a user device to an entity resource associated with the first entity for processing the first activity; determine a first resource deficiency associated with the first resource such that the first resource deficiency prevents the first resource quantity to be transmitted in the first transmission direction from the first resource; determine one or more adapted mitigation resources that are structured for augmenting the first resource, such that the augmented first resource is structured for transmitting the first resource quantity in the first transmission direction from the augmented first resource; transmit a control signal to a second networked device associated with the first entity, wherein the control signal is structured to cause the second networked device to scan a predetermined vicinity radius around the first networked device to identify devices having a multi-channel cognitive resource platform application; in response to identifying the multi-channel cognitive resource platform application on a user device, automatically activate a display device of the user device and initiate presentation of a first interface associated with the one or more adapted mitigation resources; in response to receiving a user input via the first interface of the display device of the user device, structure a first adapted mitigation resource of the one or more adapted mitigation resources such that the first adapted mitigation resource comprises a first directional trigger token structured to automatically trigger transmission of the first resource quantity from the first resource to the entity resource upon receipt at the first resource; transmit a first adapted mitigation resource of the one or more adapted mitigation resources to the first resource in second transmission direction; trigger, via the first directional trigger token, transmission of the first resource quantity from the first resource to the entity resource associated with the first entity in the first transmission direction; process the resource activity processing data for completing the first activity; and transmit a notification to the first networked device indicating the completion of the first activity.

In some embodiments, or in combination with any of the previous embodiments, the first directional trigger token is structured to (i) prevent transmission of a second resource quantity different from the first resource quantity from the first resource, and/or (ii) prevent transmission from the first resource to a second resource different from the entity resource.

In some embodiments, or in combination with any of the previous embodiments, the invention is structured to analyze resource data associated with a resource utilization data associated with the first resource, wherein the resource utilization data comprises temporal resource quantity levels, future resource transmission to the first resource in the second transmission direction; and construct the one or more adapted mitigation resources based on the resource utilization data.

In some embodiments, or in combination with any of the previous embodiments, the first directional trigger token is structured to automatically pre-stage the first interface of the display device of the user device for the transmission of the first resource quantity from the first resource to the entity resource at the user. Here, the invention is structured to receive confirmation from the user for the transmission of the first resource quantity from the first resource to the entity resource at the user.

In some embodiments, or in combination with any of the previous embodiments, the invention is structured to: establish an operative communication link between the second networked device and the user device, wherein establishing the operative communication link comprises establishing a handshake between an entity intelligent platform application associated with the second networked device and the multi-channel cognitive resource platform application of the user device; construct a first device code associated with authenticating the first activity; transmit the constructed first device code to the user device, wherein transmitted first device code is structured to cause the multi-channel cognitive resource platform application of the user device to: transform the first device code into a format compatible with the operative communication link with the second networked device; and output the transformed first device code to the entity intelligent platform application of the second networked device via the operative communication link; identify a code match, at the entity intelligent platform application of the second networked device, between the transformed first device code output by the user device and the constructed first device code; and authenticate the first activity based on the identified code match.

In some embodiments, or in combination with any of the previous embodiments, establishing the handshake between the entity intelligent platform application associated with the second networked device and the multi-channel cognitive resource platform application of the user device, comprises: transmitting, from the entity intelligent platform application associated with the second networked device, an entity synchronize message comprising an entity sequence number to the multi-channel cognitive resource platform application of the user device; receiving, at the entity intelligent platform application associated with the second networked device, a user device synchronize acknowledgment message comprising (i) a modified entity sequence number, and (ii) a user device sequence number, from the multi-channel cognitive resource platform application of the user device; and transmitting, from the entity intelligent platform application associated with the second networked device, an entity synchronize acknowledgment message comprising a modified user device sequence number to the multi-channel cognitive resource platform application of the user device.

In some embodiments, or in combination with any of the previous embodiments, the second networked device associated with the first entity comprises a beacon transmitter device.

In some embodiments, or in combination with any of the previous embodiments, causing the second networked device to scan a predetermined vicinity radius around the first networked device further comprises: activating a plurality of transmitter devices proximate the first networked device associated with the first entity; causing each of the plurality of transmitter devices to transmit a predetermined signal to scan for devices having the multi-channel cognitive resource platform application, wherein the multi-channel cognitive resource platform application is structured to read the predetermined signal and transmit a response upon receiving the predetermined signal; identifying, via a first transmitter device of the plurality of transmitter devices, the multi-channel cognitive resource platform application on the user device; and disabling the plurality of transmitter devices associated with the first entity.

### BRIEF DESCRIPTION OF THE DRAWINGS

Having thus described embodiments of the invention in general terms, reference will now be made to the accompanying drawings, where:

FIG. 1A illustrates a schematic representation 100A of a processing system and environment, in accordance with embodiments of the present invention;

FIG. 1B illustrates a schematic representation 100B of the processing system and environment of FIG. 1A, in accordance with embodiments of the present invention;

FIG. 2 illustrates a schematic representation 200 of a user device, in accordance with embodiments of the present invention;

FIG. 3A illustrates a high-level process flow 300A for adaptive dynamic multi-directional resource transmissions, in accordance with embodiments of the present invention; and

FIG. 3B illustrates a high-level process flow 300B for adaptive dynamic multi-directional resource transmissions, in continuation with the process flow 300A of FIG. 3A.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a merchant, a seller, a store, a financial institution, and/or the like. In some embodiments, a “merchant” may be defined as any organization, entity, or the like providing product or services for sale to a user. In some embodiments, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish a resource or an account with the entity. A “resource” or “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, user information provided by the user, or the like. The account is associated with and/or maintained by an entity. In other embodiments, an “entity” may not be a financial institution.

Unless specifically limited by the context, a “user activity”, “transaction” “technology activity”, or “activity” refers to any communication between the user and an entity (e.g., a merchant, a financial institution, and/or another entity). In some embodiments, for example, a user activity may refer to a purchase of goods or services, a return of goods or services, a payment transaction, a credit transaction, or other interaction involving a user's resource, e.g., bank account. As another example, in some embodiments, a user activity may refer to viewing account balances, modifying user information and contact information associated with an account, modifying alert/notification preferences, viewing transaction/activity history, transferring/redeeming loyalty points and the like. In some embodiments, the user activity is associated with an entity application stored on a user device, for example, a digital wallet application, a mobile/online banking application, a merchant application, a browser application, a social media application and the like. Typically, a user activity is an electronic transaction or electronic activity in which the user is employing a mobile device, computing device, or other electronic device to initiate, execute and/or complete the activity.

As used herein, a “technology resource” or “resource” may refer to a bank account, a credit account, a debit/deposit account, or the like. Although the phrase “bank account” includes the term “bank,” the account need not be maintained by a bank and may, instead, be maintained by other financial institutions. For example, in the context of a financial institution, a user activity or transaction may refer to one or more of a sale of goods and/or services, an account balance inquiry, a rewards transfer, an account money transfer, opening a bank application on a user's computer or mobile device, a user accessing their e-wallet (e.g., mobile wallet) or online banking account or any other interaction involving the user and/or the user's device that is detectable by the financial institution. As further examples, a user activity may occur when an entity associated with the user is alerted via the transaction of the user's location. A user activity may occur when a user accesses a building or a dwelling, uses a rewards card, and/or performs an account balance query. A user activity may occur as a user's device establishes a wireless connection, such as a Wi-Fi connection, with a point-of-sale terminal. In some embodiments, a user activity may include one or more of the following: purchasing, renting, selling, and/or leasing goods and/or services (e.g., groceries, stamps, tickets, DVDs, vending machine items, and the like); withdrawing cash; making payments (e.g., paying monthly bills; paying federal, state, and/or local taxes; and the like); sending remittances; transferring balances from one account to another account; loading money onto stored value cards (SVCs) and/or prepaid cards; donating to charities; and/or the like.

In some embodiments, a “technology resource” or “resource” may refer to an online banking account, such as an account that is associated with one or more user accounts at a financial institution. For example, the user may have an online banking account that is associated with the user's checking account, savings account, investment account, and/or credit account at a particular financial institution. Authentication credentials comprising a username and password are typically associated with the online banking account and can be used by the user to gain access to the online banking account. The online banking account may be accessed by the user over a network (e.g., the Internet) via a computer device, such as a personal computer, laptop, or mobile device (e.g., a smartphone or tablet). The online banking account may be accessed by the user via a mobile or online banking website or via a mobile or online banking application. A customer may access an online banking account to view account balances, view transaction history, view statements, transfer funds, and pay bills. More than one user may have access to the same online banking account. In this regard, each user may have a different username and password. Accordingly, one or more users may have a sub-account associated with the online banking account.

In some embodiments, a “user” may be an individual or group of individuals associated with user activities such as purchases from an entity such as a merchant. In some embodiments, a “user” may be an individual or group of individuals associated with resources (e.g., accounts, credit cards, etc.) at an entity such as a financial institution. In some embodiments, the “user” may be a financial institution user (e.g., an account holder or a person who has an account (e.g., banking account, credit account, or the like)). In one aspect, a user may be any financial institution user seeking to perform user activities associated with the financial institution or any other affiliate entities associated with the financial institution. In some embodiments, the user may be an individual who may be interested in opening an account with the financial institution. In some other embodiments, a user may be any individual who may be interested in the authentication features offered by the financial institution/entity. In some embodiments, a “user” may be a financial institution employee capable of operating the system described herein. For purposes of this invention, the term “user” and “customer” may be used interchangeably.

Networked devices, also referred to as electronic devices, such as computer terminals, point of sale terminals, portable multi-function devices, such as laptop computers, tablet computers, mobile phones, smart phones, wearable devices, are commonly used by individuals to perform a variety of activities. Typically, individuals may also have a mobile user device with them. These network devices/electronic devices may enable performance of user activities (e.g., financial activities, purchases, resource transfers, accessing resource data stored at other systems and databases and the like) based on requisite authorization. These network devices/electronic devices may also be configured to allow the user to perform the one or more user activities, transactions or resource transfers through an application, accept authentication credentials from the user, transmit authentication credentials for validation at external systems, etc.

An activity may be initiated by a networked device. Typically, certain electronic activities require a chain of transmissions, e.g., a first transmission from an originating first networked device to an authorizing second networked device, and a subsequent second transmission from the second networked device to a processing recipient system. However, in conventional systems, once initiated, the activity, specifically parameters of the transmitted activity data, cannot be modified, for example, in the instances where a resource deficiency has been identified after initiation of the activity. Any alteration, if at all possible, requires abandoning the existing activity and initiating yet another activity from the beginning with new parameters. This requires increased processing capacity and may be detrimental to communication speeds due to the large number of activities initiated. This results in increased processing delays, and squandered processing resources. Moreover, conventional systems lack the ability to mitigate resource deficiencies associated with network devices. A need exists for systems and methods for improving the functionality and processing capability of networked devices for dynamically performing activities.

The present invention addresses the foregoing needs and also provides improvement to technology by improving the functionality of and processing capability of networked devices, by configuring the networked devices for proactive combination of temporal resource activity data and dynamic transmission of resources. Specifically, the invention is structured for dynamically authenticating an activity between network devices, and identifying and mitigating resource deficiencies associated with network devices. The invention further tailors/structures the adapted mitigation resource to be compatible only with the initiated activity, preventing unsecured transmission of resources by unauthorized individuals, and increasing the resource and data security of the adapted mitigation resource, thereby providing several advantages. Here, the invention is structured for implementing adapted mitigation resources at one or more network devices in real-time, and without requiring discontinuation of the activity, which provides an improvement over existing technology systems, and provides solutions to the above listed problems inherent in existing systems, as well.

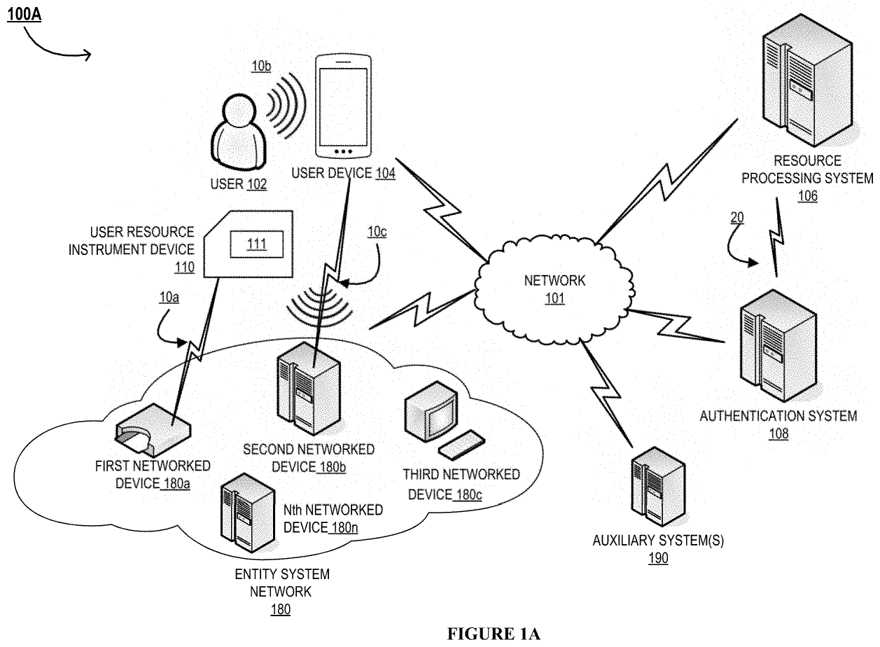

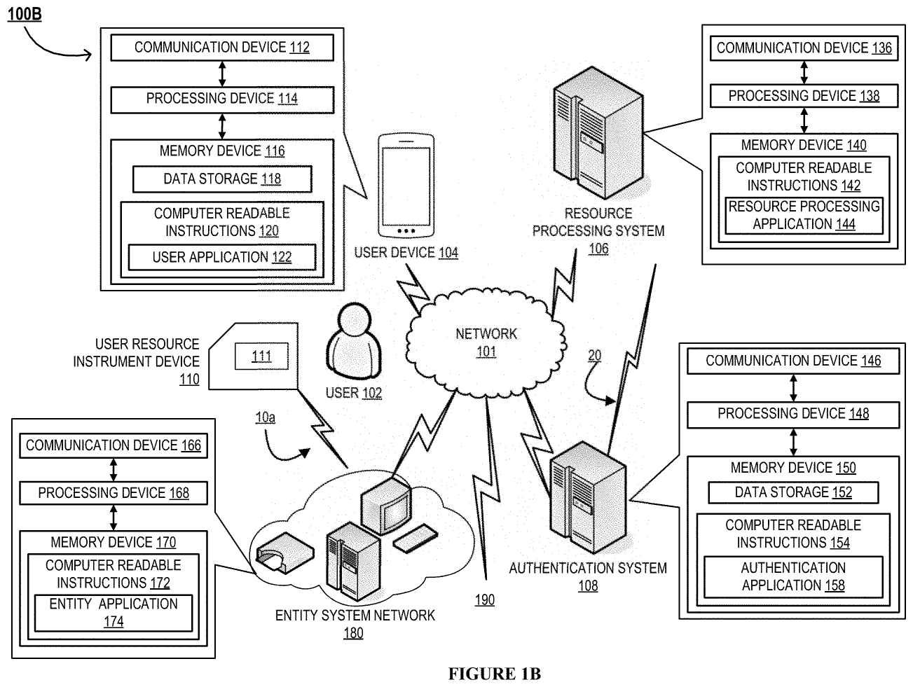

FIGS. 1A-1B illustrate schematic representations 100A and 100B of a processing system and environment 100, in accordance with embodiments of the present invention. FIGS. 1A-1B provide a unique system that includes specialized servers and systems, communicably linked across a distributive network of nodes required to perform the functions of adaptive dynamic multi-directional resource transmissions. The processing system and environment 100 provides a dynamic platform for authenticating an activity between network devices, identifying resource deficiencies associated with network devices, and deploying adapted mitigation resources at one or more network devices in real-time, and without requiring discontinuation of the activity. As illustrated in FIGS. 1A-1B, the resource processing system 106 or application server is operatively coupled, via a network 101 to the user device 104, to the authentication system 108, and one or more devices of an entity system network 180 (e.g., first networked device 180a, second networked device 180b, third networked device 180c, . . . , N^{th} networked device 180n, and/or the like) and to one or more auxiliary systems 190. In this way, the resource processing system 106 or financial institution server can send information to and receive information from the user device 104, the authentication system 108, the auxiliary systems 190, etc. FIGS. 1A-1B illustrates only one example of an embodiment of the system environment 100, and it will be appreciated that in other embodiments one or more of the systems, devices, or servers may be combined into a single system, device, or server, or be made up of multiple systems, devices, or servers.

The network 101 may be a system specific distributive network receiving and distributing specific network signals and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101. In some embodiments, the network 101 may enable communication between devices thorough near-field communication, transmission of electromagnetic waves, sound waves or any other suitable means. In some embodiments, the network 101 includes the internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user mobile device 104 and the second networked device 180b). In this regard, the wireless communication channel may further comprise near field communication (NFC), communication via radio waves, communication through the internet, communication via electromagnetic waves and the like.

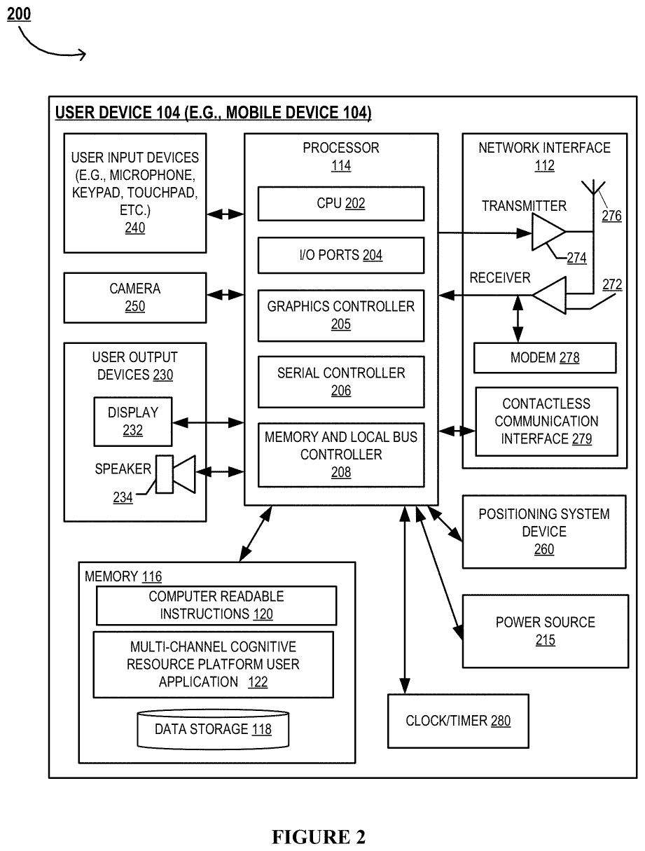

In some embodiments, the user 102 is an individual that has a user device 104, such as a mobile phone, tablet, or the like. The user device 104 may be, for example, a desktop personal computer, a mobile system, such as a cellular phone, smart phone, personal data assistant (PDA), laptop, or the like. The user device 104 generally comprises a communication device 112, a processing device 114, and a memory device 116. The user device 104 may comprise other devices that are not illustrated, configured for location determination/navigation (GPS devices, accelerometers and the like), for authentication (fingerprint scanners, microphones, iris scanners and the like), for image capture (cameras, AR devices and the like), for display (screens, hologram projectors and the like), and other purposes, as will be described with respect to FIG. 2 later on. The user device 104 is a computing system that enables the user to perform one or more authentication functions for one or more user activities. The processing device 114 is operatively coupled to the communication device 112 and the memory device 116. The processing device 114 uses the communication device 112 to communicate with the network 101 and other devices on the network 101, such as, but not limited to the resource processing system 106, the compatible devices (180a-180n) of the entity system network 180 and the authentication system 108. As such, the communication device 112 generally comprises a modem, server, or other device for communicating with other devices on the network 101. In some embodiments, the user device 104 may comprise one or more user devices comprising mobile phones, tablets, smartphones, computers and wearable devices like smart watches, glasses, jewelry, fitness and activity monitors and the like.

The user device 104 comprises computer-readable instructions 120 and data storage 118 stored in the memory device 116, which in one embodiment includes the computer-readable instructions 120 of a user application 122. The user application 122 is also referred to as a “multi-channel cognitive resource platform user application 122” or a “multi-channel cognitive resource platform application 122,” as will be described with respect to FIG. 2 later on. In some embodiments user device 104 may refer to multiple user devices that may be configured to communicate with the authentication system and/or the resource processing system 106 via the network 101. The user application 122 or the multi-channel cognitive resource platform user application 122 may be a standalone application configured for dynamic authentication assessment or the user application 122 may refer to one or more existing applications on the user device. In some embodiments the authentication system 108 and/or the resource processing system 106 may transmit control signals to the user device, configured to cause the user application 122 to perform one or more functions or steps associated with adaptive dynamic multi-directional resource transmissions. The user 102 may communicate with the user device 104 via a proximity communication channel 10b involving, audio communication, gesture-based communication, video communication, textual communication, biometric based communication, and/or the like.

The user 102 may further be associated with a resource instrument device 110. Typically, the resource instrument device 110 comprises an integrated circuit chip 111 and an antenna (not illustrated). The resource instrument device 110 is structured for contactless communication with the first networked device 180a (e.g., a chip-card reader 180a at a point of sale terminal, a point of sale terminal, an ATM, etc.) of the entity system network 180 via a first proximity channel 10a. Communication via the first proximity channel 10a comprises communications using near field communication and/or radio frequency communication (RFID). In some embodiments, the resource instrument device 110 comprises credit or debit cards structured for contactless payment. The embedded integrated circuit chip 111 and antenna allow for the user 102 to wave their resource instrument device 110 proximate a reader at the first networked device 180a (e.g., a chip-card reader 180a at a point of sale terminal, a point of sale terminal, an ATM, etc.) of the entity system network 180, e.g., for performing resource transfers (e.g., payments) for a user activity (e.g., purchase).

As further illustrated in FIGS. 1A-1B, the authentication system 108 generally comprises a communication device 146, a processing device 148, and a memory device 150. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 148 is operatively coupled to the communication device 146 and the memory device 150. The processing device 148 uses the communication device 146 to communicate with the network 101 and other devices on the network 101, such as, but not limited to the resource processing system 106, the user device 104 and the auxiliary systems 190. As such, the communication device 146 generally comprises a modem, server, or other device for communicating with other devices on the network 101.

As further illustrated in FIGS. 1A-1B, the authentication system 108 comprises computer-readable instructions 154 stored in the memory device 150, which in one embodiment includes the computer-readable instructions 154 of an authentication application 158. In some embodiments, the memory device 150 includes data storage 152 for storing data related to the system environment, but not limited to data created and/or used by the authentication application 158. In some embodiments, the authentication application 158 provides assessment of network authentication requirements based on situational instance. The authentication application 158 may comprise a proximity analyzer application 158a (not illustrated), an authentication analyzer application 158b (not illustrated), and/or the like.

In the embodiment illustrated in FIGS. 1A-1B and described throughout much of this specification, the authentication application 158 is structured for adaptive dynamic multi-directional resource transmissions. In some embodiments, the authentication system 108 may retrieve user authentication information, financial information, and the like from the resource processing system 106. In some embodiments, the authentication application 158 may receive activity data associated with prior completed resource activity processing data associated with the user from the resource processing system 106. In this way, the authentication application 158 may communicate with the resource processing system 106, the user device 104, auxiliary system(s) 190, merchant systems and other third-party systems to determine authentication requirements for a particular activity.

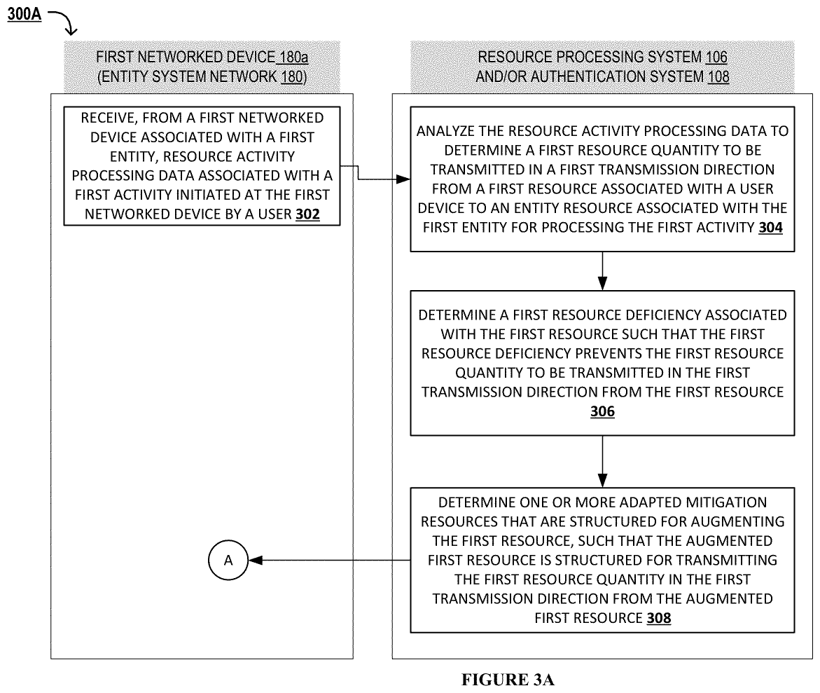

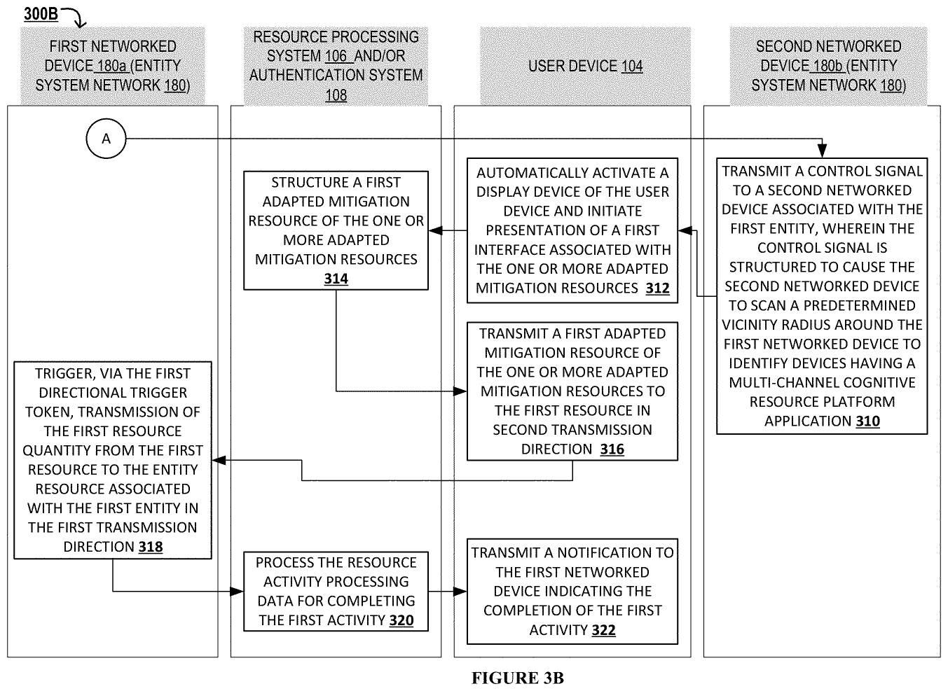

In some embodiments, the authentication application 158 may control the functioning of the user device 104. In some embodiments, the authentication application 158 computer readable instructions 154 or computer-readable program code, the when executed by the processing device 148, causes the processing device to perform one or more steps involved in adaptive dynamic multi-directional resource transmissions, and/or transmit control instructions to other systems and devices to cause the systems and devices to perform specific tasks, as described with respect to process flows 300A-300B of FIG. 3A-FIG. 3B.

As illustrated in FIGS. 1A-1B, the resource processing system 106 is connected to the authentication system 108 and is associated with a financial institution network. In this way, while only one resource processing system 106 is illustrated in FIGS. 1A-1B, it is understood that multiple network systems may make up the system environment 100. The resource processing system 106 generally comprises a communication device 136, a processing device 138, and a memory device 140. The resource processing system 106 comprises computer-readable instructions 142 stored in the memory device 140, which in one embodiment includes the computer-readable instructions 142 of a resource processing application 144. The resource processing system 106 may communicate with the authentication system 108 to provide authentication credentials for user activities. The authentication system 108 may communicate with the resource processing system 106 via a secure connection 20 generated for secure encrypted communications between the two systems for ascertaining authentication requirements. In some embodiments, the secure connection 20 may be an operative communication link/channel established via the network 101.

As illustrated in FIGS. 1A-1B, the processing system and environment comprises an entity system network 180 having one or more devices, such as, a first networked device 180a, a second networked device 180b, a third networked device 180c, . . . , an N^{th} networked device 180n, and/or the like. In some embodiments, the first networked device 180a is a chip-card reader at a point of sale terminal, a point of sale terminal, an ATM, and/or the like, structured for contactless communication with the resource instrument device 110 via the first proximity channel 10a. Communication via the first proximity channel 10a comprises communications using near field communication and/or radio frequency communication (RFID). This allows for the user 102 to wave their resource instrument device 110 proximate a reader at the first networked device 180a (e.g., a chip-card reader 180a at a point of sale terminal, a point of sale terminal, an ATM, etc.) of the entity system network 180, e.g., for performing resource transfers (e.g., payments) for a user activity (e.g., purchase). The second networked device 180b may refer to an entity device or group of devices (e.g., a beacon, a transmitter device, a beacon transmitter, a sensor device, a processing device, and/or the like, and/or a combination of the foregoing) having an entity intelligent platform application stored thereon. The entity intelligent platform application may be similar to the multi-channel cognitive resource platform application associated with the user device 104. The second networked device 180b is structured to scan a predetermined vicinity around the first networked device to identify devices having a multi-channel cognitive resource platform. The second networked device 180b is structured to establish an operative communication link 10c with the user device 104. Here, establishing the operative communication link comprises establishing a handshake between an entity intelligent platform associated with the second networked device and the multi-channel cognitive resource platform of the user device. Moreover, the second networked device 180b is structured to identify a code match between the transformed first device code output by the user device and the constructed first device code, via the entity intelligent platform of the second networked device, as will be described with respect to FIGS. 4A and 4B.

In some embodiments, each of the one or more devices of the entity system network 180 (e.g., first networked device 180a, second networked device 180b, third networked device 180c, . . . , N^{th} networked device 180n, and/or the like) may comprise a communication device 166, a processing device 168, and a memory device 170. The memory device 170 may further comprise computer readable instructions 172, and an entity application 174. For the second networked device 180b, the entity application 174 may refer to the entity intelligent platform application 174. In some embodiments, the entity intelligent platform application 174 is substantially similar to the multi-channel cognitive resource platform application 122, except that it is structured for performing back-end resource processing activities of the entity (while the multi-channel cognitive resource platform application 122 is user-facing and is structured for user interaction based activities).

The auxiliary system(s) 190 may be similar to the user device 104 and/or the resource processing system 106. The auxiliary system(s) 190 may comprise a communication device, a processing device, and a memory device having one or more applications.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 2 illustrates a schematic representation 200 of a user device 104, in accordance with embodiments of the present invention. The user device 104 may also be referred to as a “user mobile device” 104 may be any mobile communication device, such as a cellular telecommunications device (i.e., a cell phone or mobile phone), personal digital assistant (PDA), a mobile Internet accessing device, or another user mobile device including, but not limited to portable digital assistants (PDAs), pagers, mobile televisions, gaming devices, laptop computers, cameras, video recorders, audio/video player, radio, GPS devices, any combination of the aforementioned devices.

The user mobile device 104 may generally include a processing device or processor 114 communicably coupled to devices such as, a memory device 116, user output devices 230 (for example, a user display device 232, or a speaker 234), user input devices 240 (such as a microphone, keypad, touchpad, touch screen, and the like), a communication device or network interface device 112, a power source 215, a clock or other timer 280, a visual capture device such as a camera 250, a positioning system device 260, such as a geo-positioning system device like a GPS device, an accelerometer, and the like, one or more chips, and the like. The processor 114 may further include a central processing unit 202, input/output (I/O) port controllers 204, a graphics controller 205, a serial bus controller 206 and a memory and local bus controller 208.

The processor 114 may include functionality to operate one or more software programs or applications, which may be stored in the memory device 116. For example, the processor 114 may be capable of operating applications such as the multi-channel cognitive resource platform application 122. The multi-channel cognitive resource platform application 122 may then allow the user mobile device 104 to transmit and receive data and instructions from second networked device 180b (e.g., via the channel 10c), the authentication system 108 and/or the resource processing system 106, web content, such as, for example, location-based content and/or other web page content, according to a Wireless Application Protocol (WAP), Hypertext Transfer Protocol (HTTP), and/or the like.

The multi-channel cognitive resource platform user application 122 may include the necessary circuitry to provide token storage and transmission functionality, transmitter device signal encoding and decoding functionality to the user mobile device 104, for secure transmission of financial and authentication credential tokens via the contactless communication interface 279 to the second networked device 180b. That said, in some embodiments the multi-channel cognitive resource platform user application 122 is pre-installed on the user mobile device 104, while in other embodiments, the authentication system 108 and/or the resource processing system 106 may transmit and cause installation of the application 122 based on determining that the user mobile device 104 does not comprise the application 122.

The processor 114 may be configured to use the network interface device 112 to communicate with one or more other devices on a network 101 such as, but not limited to the second networked device 180b, the authentication system 108 and/or the resource processing system 106. In this regard, the network interface device 112 may include an antenna 276 operatively coupled to a transmitter 274 and a receiver 272 (together a “transceiver”), modem 278 and a contactless communication interface 279. The processor 114 may be configured to provide signals to and receive signals from the transmitter 274 and receiver 272, respectively. The signals may include signaling information in accordance with the air interface standard of the applicable BLE standard, cellular system of the wireless telephone network and the like, that may be part of the network 101. In this regard, the user mobile device 104 may be configured to operate with one or more air interface standards, communication protocols, modulation types, and access types. By way of illustration, the user mobile device 104 may be configured to operate in accordance with any of a number of first, second, third, and/or fourth-generation communication protocols and/or the like. For example, the user mobile device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user mobile device 104 may also be configured to operate in accordance with non-cellular communication mechanisms, such as via a wireless local area network (WLAN) or other communication/data networks. The user mobile device 104 may also be configured to operate in accordance Bluetooth® low energy, audio frequency, ultrasound frequency, or other communication/data networks.

The network interface device 112 or communication device 112 may also include a user activity interface presented in user output devices 230 in order to allow a user 102 to execute some or all of processes described herein. The application interface may have access to the hardware, for example, the transceiver, and software previously described with respect to the network interface device 112. Furthermore, the application interface may have the ability to connect to and communicate with an external data storage on a separate system within the network 101. As described above, the user mobile device 104 includes a display device 232 having a user interface that includes user output devices 230 and/or user input devices 240. The user output devices 230 may include a display 232 (e.g., a liquid crystal display (LCD) or the like) and a speaker 234 or other audio device, which are operatively coupled to the processor 114. The user input devices 240, which may allow the user mobile device 104 to receive data from the user 102, may include any of a number of devices allowing the user mobile device 104 to receive data from a user 102, such as a keypad, keyboard, touch-screen, touchpad, microphone, mouse, joystick, other pointer device, button, soft key, and/or other input device(s).

The user mobile device 104 may further include a power source 215 (e.g., a rechargeable DC power source). Generally, the power source 215 is a device that supplies electrical energy to an electrical load. In some embodiment, power source 215 may convert a form of energy such as solar energy, chemical energy, mechanical energy, and the like, to electrical energy. Generally, the power source 215 in a user mobile device 104 may be a battery, such as a lithium battery, a nickel-metal hydride battery, or the like, that is used for powering various circuits, for example, the transceiver circuit, and other devices that are used to operate the user mobile device 104. Alternatively, the power source 215 may be a power adapter that can connect a power supply from a power outlet to the user mobile device 104. In such embodiments, a power adapter may be classified as a power source “in” the user mobile device 104.

As discussed previously, the user device 104 comprises computer-readable instructions 120 and data storage 118 stored in the memory device 116, which in one embodiment includes the computer-readable instructions 120 of a user application 122 (a multi-channel cognitive resource platform application 122). The user mobile device 104 may also include a memory buffer, cache memory or temporary memory device operatively coupled to the processor 114. Typically, one or more applications such as the multi-channel cognitive resource platform user application 122, are loaded into the temporarily memory during use. As used herein, memory may include any computer readable medium configured to store data, code, or other information. The memory device 116 may include volatile memory, such as volatile Random-Access Memory (RAM) including a cache area for the temporary storage of data. The memory device 116 may also include non-volatile memory, which can be embedded and/or may be removable. The non-volatile memory may additionally or alternatively include an electrically erasable programmable read-only memory (EEPROM), flash memory or the like.

In some instances, the user mobile device 104 comprises sensor devices 240 comprising biometric sensors for capturing parameters associated with the user, such as fingerprint scanners, voice recognition sensors, facial recognition sensors, heart rate sensors, user stress level sensors and the like. These biometric sensors 240 are configured to retrieve, receive, analyze and or validate biometric credentials associated with the user. In this regard, the biometric sensors 240 may comprise optical sensors, ultrasonic sensors, and/or capacitance sensors. The biometric sensors may further comprise radio frequency, thermal, pressure, piezo-resistive/piezoelectric, microelectromechanical sensors, and the like.

The functions, and features of the multi-channel cognitive resource platform user application 122 will now be described in detail. Typically, the multi-channel cognitive resource platform application 122 is structured for providing an intelligent, proactive and responsive application or system, at a user device 104, which facilitates execution of electronic activities in an integrated manner, and which is capable of adapting to the user's natural communication and its various modes by allowing seamless switching between communication channels/mediums in real time or near real time. As such, the multi-channel cognitive resource platform, and the multi-channel cognitive resource user application 122 in particular, is configured to function as an intelligent personal assistant and resource navigator and is configured to perform one or more electronic user activities by harnessing the functionality of multiple applications resident on the user device. In particular, the system is configured to present an integrated central user interface for communicating with the user via natural language or conversation channels, for execution of one or more user activities, and for integrating the functionality of multiple applications in a single interface, without requiring the user to access the multiple applications individually and be proficient in their operation.

As such, the multi-channel cognitive resource user application 122 is configured to perform one or more user activities in a convenient and timely manner, via a central user interface of the application 122. In this regard, in some embodiments, the central user interface is presented on one or more user devices via the multi-channel cognitive resource user application 122 or another user application 122. The central user interface or multi-channel cognitive resource interface associated with the user application 122 may be presented on the display device 112 of the user device 104 in response to receiving an indication from the user (for example, receiving a voice command from the user with an identifier associated with the multi-channel cognitive resource platform, receiving a tactile indication or a fingerprint authentication from a home button of the device 104, successful authentication of authentication credentials and the like), automatically in response to detecting an action trigger (for example, determining that the user is attempting to perform a user activity by using a particular application, determining that a user resource is associated with a predetermined threshold value, determining that the user is at a predetermined location and the like), and the like.

Typically, the central user interface is a computer human interface, and specifically a natural language/conversation user interface for receiving user input (for example, for creating, selecting and modifying data/functionality), presenting information regarding user activities, providing output to the user, and otherwise communicating with the user in a natural language of the user, via suitable communication mediums such as audio, textual, and the like. The natural language of the user comprises linguistic phenomena such as verbs, phrases and clauses that are associated with the natural language of the user. The system is configured to receive, recognize and interpret these linguistic phenomena of the user input and perform user activities accordingly. In this regard, the system is configured for natural language processing and computational linguistics. In many instances, the system is intuitive, and is configured to anticipate user requirements, data required for a particular activity and the like, and request activity data from the user accordingly.

In some instances, various features and functions of the invention are described herein with respect to a “system.” In some instances, the system may refer to the authentication system 108 and/or the resource processing system 106 performing one or more steps described herein in conjunction with other devices and systems, either automatically based on executing computer readable instructions of the memory device 150, or in response to receiving control instructions from the authentication system 108 and/or the resource processing system 106. In some instances, the system refers to the authentication system 108 and/or the resource processing system 106. In some instances, the system refers to the devices and systems on the network environment 100 of FIGS. 1A-1B. In some instances, the system refers to the user mobile device 104. The features and functions of various embodiments of the invention are be described below in further detail.

FIGS. 3A and 3B illustrate high-level process flows 300A-300B for adaptive dynamic multi-directional resource transmissions. The process flow involves dynamically authenticating an activity between network devices, identifying resource deficiencies associated with network devices, and deploying adapted mitigation resources at one or more network devices in real-time, and without requiring discontinuation of the activity. In some embodiments, some or all of the steps of the process flows 300A-300B are performed by the resource processing system 106, alone or in conjunction with the authentication system 108, e.g., based on causing the user device 104, the first networked device 180a, and/or the second networked device 180b to perform certain functions. In some embodiments, the “system” as used with respect to the steps 302-322 herein may refer to the resource processing system 106, or the authentication system 108 in combination with the resource processing system 106.

First, at block 302, the system may receive resource activity processing data associated with a first activity initiated at the first networked device 180a by a user, from a first networked device 180a associated with first entity. Typically, the resource activity processing data comprises a unique identifier associated with the user activity processing parameters associated with performing the first activity. These unique identifiers may be user account numbers, credit card numbers, unique username/passcode combination, and/or other user information that can uniquely identify the user.

Here, in some embodiments, the process flow 300A begins with the system receiving information regarding at least one user activity (e.g., a transaction) associated with a user initiated at a first networked device 180a (e.g., a point of sale terminal, an ATM, etc.). Moreover, the system may receive resource activity processing data from the first networked device 180a. The resource activity processing data is typically associated with a first activity initiated at the first networked device 180a. The resource activity processing data typically comprises (i) the unique identifier associated with the user, (ii) activity processing parameters such as transaction details such as amount, entity/merchant identifiers, product/service purchase details, type/categories of product/service, and/or the like, and/or (iii) user resource data (e.g., associated with payment credentials provided by the user for the activity) such as unique identifiers associated with a first resource (e.g., account identifiers) from which the first resource quantity is to be transmitted to an entity resource in the first direction for processing the first activity. In some embodiments the system, for example, the receives information regarding the operative communication and the information regarding the first activity in real time. In this regard the system may receive information regarding the first activity that the user initiates or seeks to initiate, the first activity that the user in in the process of executing and/or the first activity that the user has completed. For example, the system may receive an indication that the user wishes to initiate the first activity with the entity (e.g., one or more merchants). In some embodiments, the resource activity processing data having the unique identifier associated with the user associated with the first activity initiated at the first networked device 180a is associated with a first authentication level. In other words, the unique identifier associated with the user may be adequate for establishing a first level of authentication.

In some embodiments the system may receive the information regarding the first activity and/or perform the one or more subsequent steps of the process flows 300A-300B during the initiation of the first activity. In this instance, the seamless dynamic authentication based on establishing seamless electronic communication handshake between network devices and without requiring user intervention of process flows 300A-300B, is associated with authenticating the user, authorizing the user to perform the first activity, validating the first activity, approving the first activity and/or authorizing the first activity itself. In other embodiments, in addition to or separately from the previous embodiments, the system may receive the information regarding the first activity and/or perform one or more subsequent steps of the process flows 300A-300B during the execution of the first activity, for example in the time period between the initiation and completion of the first activity by the user. Completion of the first activity, typically includes in some embodiments, completion or termination of the first activity from the user's perspective. For example, in some embodiments, the first activity is complete when at least the user is authenticated, the payment credentials are verified the first activity is authorized and/or approved, and purchased products/services are provided/initiated/ordered, after which the user considers the first activity complete and may leave the store, log off the merchant's website/payment portal, terminate the telephone call and the like. As another example, completion of the first activity, in some embodiments, comprises the entity/merchant submitting the relevant information associated with the first activity to a financial institution/entity for settlement, placing the first activity in a pending transaction queue for settlement and the like. In some embodiments, the first activity is temporarily authorized in the completion stage and is later routed for further processing and settlement. In some embodiments, the system may receive the information regarding the first activity and/or perform the subsequent steps of the process flows 300A-300B after the completion of the first activity, for example, in the time period between the completion of the first activity by the user and the settlement of the first activity at a predetermined future settlement date, in combination with or distinctly from the previous embodiments. The predetermined future settlement date may comprise settlement of the first activity by the user's financial institution, by the entity/merchant or a financial institution associated with the merchant, debiting of the user account or posting payments after prior temporary authorization, transmitting funds associated with the first activity to the entity/merchant/merchant account and the like.

Next, at block 304, the system may analyze the resource activity processing data to determine a first resource quantity to be transmitted in a first transmission direction from a first resource associated with a user device to an entity resource associated with the first entity for processing the first activity. In this regard, the system may determine the first resource quantity to be transmitted based on the activity processing parameters such as transaction details such as amount, entity/merchant identifiers, product/service purchase details, etc. In some instances, the first resource quantity to be transmitted may be substantially to the amount/cost associated with the first activity. In some embodiments, the system may dynamically construct the first resource quantity by modifying, in real-time, the amount/cost associated with the first activity, e.g., by removing a reduction resource quantity/amount associated with rebates, accrued resources, etc., and/or adding/supplementing with an added resource quantity/amount such as shipping costs, etc.

Next, at block 306, the system may determine a first resource deficiency associated with the first resource such that the first resource deficiency prevents the first resource quantity to be transmitted in the first transmission direction from the first resource. Here, the system may extract user resource data from the resource activity processing data. The extracted user resource data may comprise unique identifiers associated with a first resource (e.g., account identifiers) from which the first resource quantity is to be transmitted to an entity resource in the first direction for processing the first activity. The system may typically determine whether the first resource quantity is available at the first resource. In some embodiments, the system may construct a simulated activity structured for determining whether the first resource quantity is available at the first resource. The simulated activity is constructed by inserting the user resource data identifying the first resource, and the simulated activity is structured to query the first resource to initiate a simulated transmission of first resource quantity in the first transmission direction from the first resource, without inducing the first resource quantity to be actually transmitted/deducted from the first resource. Upon successful result output of the simulated activity, the system may determine that first resource quantity is available at the first resource. On the other hand, based on an unsuccessful/failure result output of the simulated activity, the system may determine that first resource quantity is not available at the first resource, and hence that the first resource comprises the first resource deficiency. In this manner, the system may determine whether the first resource quantity is available at the first resource, in a secure manner, without having to extract current total resource availability or specific current parameters of the first resource, and/or the like. That said, alternatively, in other embodiments, the system may determine whether the first resource quantity is available at the first resource based on at least the current total resource availability of the first resource.

In response to the determining that first resource quantity is not available at the first resource, and hence that the first resource comprises the first resource deficiency, the system may determine whether to trigger one or more adapted mitigation resources for mitigating the first resource deficiency. Here, the system may first analyze resource data associated with a resource utilization data associated with the first resource. Typically, the resource utilization data comprises temporal resource quantity levels (e.g., average monthly resource levels), future resource transmission to the first resource in the second transmission direction (e.g., expected incoming resources from salary, etc.), associated resource instruments (e.g., digital wallets, debit/credit cards), associated second resources of the user (e.g., other accounts) and/or the like.

Next, the system may determine whether the resource utilization data is compatible for mitigating the first resource deficiency. Here the system may determine whether one or more components of the resource utilization data such as future resource transmission to the first resource in the second transmission direction, associated resource instruments, associated second resources of the user, and/or the like can be engaged for remediating the first resource deficiency. For example, the system may determine that the user is associated with another second resource (e.g., account) that comprises the first resource quantity, and/or at least the difference between available resource at the first resource and the first resource quantity, or the system may determine that the user is associated with a resource instrument that is configured for transmitting the first resource quantity, and/or at least the difference between available resource at the first resource and the first resource quantity, e.g., using simulated activities in the manner described previously. Subsequently, in response to determining one or more components of the resource utilization data are compatible for mitigating the first resource deficiency, the system may not trigger one or more adapted mitigation resources for mitigating the first resource deficiency, and instead automatically engage/deploy the one or more components in processing the first resource activity. Alternatively, in response to determining one or more components of the resource utilization data are not compatible for mitigating the first resource deficiency, the system may determine trigger one or more adapted mitigation resources for mitigating the first resource deficiency, as described below.

In response, the system may construct/determine, at block 308, one or more adapted mitigation resources that are structured for augmenting the first resource, such that the augmented first resource is structured for transmitting the first resource quantity in the first transmission direction from the augmented first resource. In some embodiments, the one or more adapted mitigation resources comprise one or more mitigation resource types such a loan type, a line of credit type, an advance payment type, and/or the like. In some embodiments, the system may construct the one or more adapted mitigation resources based on at least the resource utilization data. Here, the system may first determine the type of adapted mitigation resource to be triggered for the first activity. Here, the system may determine a deficiency resource associated with the difference between available resource at the first resource and the first resource quantity. The system may then analyze historical user data associated with prior adapted mitigation resources implemented for the user, prior resource utilization data, and/or the like. Here, the system may determine whether components of the prior resource utilization data, such as associated resource instruments (e.g., digital wallets, debit/credit cards), associated second resources of the user (e.g., other accounts) are compatible with certain adapted mitigation resources. The system may then determine/choose/construct a particular type of adapted mitigation resource based on at least (i) the deficiency resource, (ii) historical user data, (iii) compatibility with the first resource, and/or (iv) the resource utilization data. As a non-limiting example, the system may determine/choose an advance payment type based on determining that the first resource is compatible with the advance payment type and that the deficiency resource is below a predetermined threshold associated with the advance payment type. As another non-limiting example, the system may determine/choose a line of credit type based on determining that a second resource associated with the user comprises a prior line of credit and/or that the deficiency resource is between a predetermined threshold range associated with the line of credit type. As yet another non-limiting example, the system may determine/choose a loan type based on determining that the user has previously accepted a loan type of adapted mitigation resource and/or that the deficiency resource is above a predetermined threshold range associated with the loan type.

Next, the system may configure the adapted mitigation resource (e.g., the mitigation resource type determined previously) based on at least the resource activity processing data, and the resource utilization data, described previously. Here, the system may dynamically adapt the elements of the mitigation resource to specific parameters of the resource activity processing data, and the resource utilization data. The elements of the mitigation resource may comprise type of delivery of resources (e.g., one-time, periodic, installments, etc.), timeframe of delivery, adapted resource quantity/amount, type of subsequent return/repayment by the user (e.g., one-time, periodic, installments, etc.), timeframe of subsequent return/repayment by the user, and/or the like. As a non-limiting example, the system may construct a loan type adapted mitigation resource with a loan resource quantity/amount parameter being the first resource quantity to be delivered/transmitted to the first resource in the second direction, with a subsequent return/repayment timeframe parameter of a first time interval (e.g., based on analyzing the resource utilization data and identifying an expected future resource transmission to the first resource at or prior to the beginning of the first time interval). As another non-limiting example, the system may construct an advance payment type adapted mitigation resource with a resource quantity/amount to be delivered/transmitted to an intermediate second resource compatible with the advance payment and then automatically transferred to the first resource in the second direction in two installments. In some embodiments, the system may configure a plurality of adapted mitigation resources, and display the configured plurality of resources on a first interface of the user device for the user to choose from (e.g., as described later with respect to block 312).

In addition, in some embodiments, during construction of the adapted mitigation resource, the system may embed/insert a first directional trigger token therein. The first directional trigger token is structured to automatically trigger transmission of the first resource quantity from the first resource to the entity resource upon receipt of the adapted mitigation resource at the first resource. Moreover, the first directional trigger token is structured to (i) prevent transmission of a second, modified, resource quantity different from the first resource quantity from the first resource, and/or (ii) prevent transmission from the first resource to a second resource different from the entity resource. In this way, the system tailors/structures the adapted mitigation resource to be compatible only with the first activity, preventing unsecured transmission of resources by unauthorized individuals, and increasing the resource and data security of the adapted mitigation resource, thereby providing several advantages.

Subsequently, at block 310, transmit a control signal to a second networked device 180b associated with first entity. Typically, the control signal is structured to cause the second networked device 180b to scan a predetermined vicinity (e.g., 1 to 5 feet, 0 to 10 feet, and/or the like) around the first networked device 180a to identify devices having a multi-channel cognitive resource platform user application 122. The user device 104 may be a mobile phone, a smart phone, a wearable device, a computer, a personal digital assistant or another computing device, having the multi-channel cognitive resource platform user application 122. In some embodiments, the second networked device 180b associated with the first entity comprises a beacon transmitter device.

In some embodiments, the second networked device 180b is associated with the plurality of transmitter devices. Here, for scanning a predetermined vicinity radius around the first networked device 180a, the system may first activate the plurality of transmitter devices (e.g., beacon transmitters) proximate the first networked device 180a associated with the first entity. The system may then cause each of the plurality of transmitter devices to transmit a predetermined signal. The predetermine signal may comprise signal characteristics (e.g., frequency, modulation, encryption, content, encoding, content, etc.) such that only the multi-channel cognitive resource platform application 122 (and not other 3^{rd} party applications of the user device) is equipped to read, i.e., identify and process the signal and send a read receipt/confirmation. In other words, the multi-channel cognitive resource platform application 122 is structured to read the predetermined signal and transmit a response upon receiving the predetermined signal. Each of the transmitter devices may comprise a unique signal, and cause the multi-channel cognitive resource platform application 122 to transmit unique read receipt/confirmation response that can be traced back to the particular transmitter device. Upon receipt of the receipt/confirmation response, the system may identify the multi-channel cognitive resource platform application 122 as well as the user device 104 that it is resident on. Next, the system may disable the plurality of transmitter devices associated with the first entity.

Next, the system may authenticate the user device 104 for the first activity. Here, the system may establish an operative communication link between the second networked device and the user device. Typically, establishing the operative communication link comprises establishing a handshake between an entity intelligent platform application associated with the second networked device and the multi-channel cognitive resource platform application of the user device. Typically, to establish the handshake, the system may first transmit, from the entity intelligent platform application associated with the second networked device, an entity synchronize message comprising an entity sequence number to the multi-channel cognitive resource platform application of the user device. Next, the entity intelligent platform application associated with the second networked device may receive a user device synchronize acknowledgment message comprising (i) a modified entity sequence number, and (ii) a user device sequence number, from the multi-channel cognitive resource platform application of the user device. Subsequently, the entity intelligent platform application associated with the second networked device may transmit an entity synchronize acknowledgment message comprising a modified user device sequence number to the multi-channel cognitive resource platform application of the user device.

Furthermore, for authenticating the user device 104 for the first activity, the system may construct a first device code associated with authenticating the first activity and transmit the constructed first device code to the user device. Typically, the first device code is structured to cause the multi-channel cognitive resource platform application of the user device to (i) transform the first device code into a format compatible with the operative communication link with the second networked device; and (ii) output the transformed first device code to the entity intelligent platform application of the second networked device via the operative communication link. Next, the system may identify a code match between the transformed first device code output by the user device and the constructed first device code, at the entity intelligent platform application of the second networked device. Subsequently, the system may authenticate the first activity based on the identified code match, i.e., authenticate the user device 104 for the first activity.

In response to identifying the multi-channel cognitive resource platform user application 122 on a user device 104 and/or authenticating the user device 104 for the first activity, the system may automatically activate a display device of the user device and initiate presentation of a first interface associated with the one or more adapted mitigation resources, as indicated by block 312. Here, the activation of the display device may include overlaying an existing display of the user device with the presentation of the first interface, and/or the activation of the display device may be accompanied by a predetermined beep, or vibration pattern. The presentation of the first interface is structured to be displayed constantly and prevent display of other interfaces except in a notification/pop-up format or split-screen format until the user provides predetermined user input/response at the first interface. Subsequently user may provide a user input comprising confirmation from the user for the transmission of the first resource quantity from the first resource to the entity resource at the user, selection of a first adapted mitigation resource of the displayed one or more/plurality of adapted mitigation resources, authentication credentials, and/or authorization to implement the adapted mitigation resource.

Subsequently at block 314, in response to receiving a user input via the first interface of the display device of the user device, the system may structure a first adapted mitigation resource of the one or more adapted mitigation resources such that the first adapted mitigation resource comprises a first directional trigger token structured to automatically trigger transmission of the first resource quantity from the first resource to the entity resource upon receipt at the first resource. Typically, structuring the first adapted mitigation resource of the one or more adapted mitigation resources is the same as or substantially similar to that described previously, e.g., with respect to block 308. In this regard, the system may embed/insert a first directional trigger token in response to determining that it was not previously embedded at block 308. As discussed previously, the first directional trigger token is structured to automatically trigger transmission of the first resource quantity from the first resource to the entity resource upon receipt of the adapted mitigation resource at the first resource. Moreover, the first directional trigger token is structured to (i) prevent transmission of a second, modified, resource quantity different from the first resource quantity from the first resource, and/or (ii) prevent transmission from the first resource to a second resource different from the entity resource. In this way, the system tailors/structures the adapted mitigation resource to be compatible only with the first activity, preventing unsecured transmission of resources by unauthorized individuals, and increasing the resource and data security of the adapted mitigation resource, thereby providing several advantages. Moreover, the first directional trigger token is structured to automatically pre-stage the first interface of the display device of the user device for the transmission of the first resource quantity from the first resource to the entity resource at the user. Here, pre-staging the first interface may comprise not only configuring the first interface to display the one or more one or more adapted mitigation resources, but also encoding the adapted mitigation resource data such that only the multi-channel cognitive resource platform application 122 is structured to decode the data, thereby increasing the security of the adapted mitigation resource data and preventing unauthorized access.

The system may then transmit a first adapted mitigation resource of the one or more adapted mitigation resources to the first resource in second transmission direction, as indicated by block 316. This typically causes an available resource quantity of the first resource to increase. As indicated by block 318, the system may trigger, via the first directional trigger token, transmission of the first resource quantity from the first resource to the entity resource associated with the first entity in the first transmission direction for processing the first activity. Next, as indicted by block 320, the system may process the resource activity processing data for completing the first activity. Finally, the system may transmit a notification to the first networked device 180a indicating the completion of the first activity, as indicated by block 322.

Moreover, in some embodiments, similar to the construction and deployment of the adapted mitigation resources for the first resource of the user, as described previously with respect to blocks 302-322 above, the system may also deploy additional resources to the entity resource associated with the first entity. Here, the system may electronically receive a request for one or more additional resources to be deployed to the entity resource associated with the first entity. The one or more additional resources may be substantially similar to the adapted mitigation resources described above. For instance, the one or more additional resources may comprise at least a new line of credit with a first entity, such that the new line of credit comprises at least a line amount and an interest rate. Moreover, the system may determine an entity resource capacity based on at least an entity resource utilization information of the entity. Here, the system may determine a lending score associated with the entity, such that the lending score is indicative of an eligibility of the entity to receive the new line of credit. The system may further determine a first set of actions to be executed by the entity to receive an optimal alternative line amount at an optimal alternative interest rate.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A system for adaptive dynamic multi-directional resource transmissions, wherein the system is structured for dynamically authenticating an activity between network devices based on establishing seamless electronic communication handshake between network devices, and deploying adapted mitigation resources, without requiring discontinuation of the activity, the system comprising:
a first networked device associated with a first entity;
a second networked device associated with the first entity;
at least one memory device comprising executable instructions stored thereon;
at least one communication device connected to a distributed network;
at least one processing device operatively coupled to the at least one memory device, wherein
executing the executable instructions is configured to cause the at least one processing device to:
receive, from the first networked device associated with the first entity, resource activity processing data associated with a first activity initiated at the first networked device by a user;
analyze the resource activity processing data to determine a first resource quantity to be transmitted in a first transmission direction from a first resource associated with a user device to an entity resource associated with the first entity for processing the first activity;
determine a first resource deficiency associated with the first resource such that the first resource deficiency prevents the first resource quantity to be transmitted in the first transmission direction from the first resource;
determine one or more adapted mitigation resources that are structured for augmenting the first resource, such that the augmented first resource is structured for transmitting the first resource quantity in the first transmission direction from the augmented first resource;
transmit a control signal to the second networked device associated with the first entity, wherein the control signal is structured to cause the second networked device to scan a vicinity radius around the first networked device to identify devices having a multi-channel cognitive resource platform application;
authenticate the user device for the first activity, comprising:
establishing an operative communication link between the second networked device and the user device, wherein establishing the operative communication link comprises establishing a handshake between an entity intelligent platform application associated with the second networked device and the multi-channel cognitive resource platform application of the user device;
constructing a first device code associated with authenticating the first activity;
transmitting the constructed first device code to the user device;
identifying a code match, at the entity intelligent platform application of the second networked device, between a transformed first device code output by the user device and the constructed first device code; and
authenticating the first activity based on the identified code match;
automatically activate a display device of the user device and initiate presentation of a first interface associated with the one or more adapted mitigation resources;
in response to receiving a user input via the first interface of the display device of the user device, structure a first adapted mitigation resource of the one or more adapted mitigation resources such that the first adapted mitigation resource comprises a first directional trigger token structured to automatically trigger transmission of the first resource quantity from the first resource to the entity resource upon receipt at the first resource;
transmit a first adapted mitigation resource of the one or more adapted mitigation resources to the first resource in second transmission direction;
trigger, via the first directional trigger token, transmission of the first resource quantity from the first resource to the entity resource associated with the first entity in the first transmission direction;
process the resource activity processing data for completing the first activity; and
transmit a notification to the first networked device indicating the completion of the first activity.

2. The system of claim 1, wherein the first directional trigger token is structured to (i) prevent transmission of a second resource quantity different from the first resource quantity from the first resource, and (ii) prevent transmission from the first resource to a second resource different from the entity resource.

3. The system of claim 1, wherein the executable instructions when executed by the at least one processing device further cause the at least one processing device to:
analyze resource data associated with a resource utilization data associated with the first resource, wherein the resource utilization data comprises temporal resource quantity levels, future resource transmission to the first resource in the second transmission direction; and
construct the one or more adapted mitigation resources based on the resource utilization data.

4. The system of claim 1, wherein the first directional trigger token is structured to automatically pre-stage the first interface of the display device of the user device for the transmission of the first resource quantity from the first resource to the entity resource at the user, wherein automatically activating the display device of the user device further comprises preventing display of a second interface until receipt of the user input at the first interface of the display device of the user device; wherein the executable instructions when executed by the at least one processing device further cause the at least one processing device to receive confirmation from the user for the transmission of the first resource quantity from the first resource to the entity resource at the user.

5. The system of claim 1,
wherein transmitted first device code is structured to cause the multi-channel cognitive resource platform application of the user device to:
transform the first device code into a format compatible with the operative communication link with the second networked device; and
output the transformed first device code to the entity intelligent platform application of the second networked device via the operative communication link.

6. The system of claim 1, wherein establishing the handshake between the entity intelligent platform application associated with the second networked device and the multi-channel cognitive resource platform application of the user device, comprises:
transmitting, from the entity intelligent platform application associated with the second networked device, an entity synchronize message comprising an entity sequence number to the multi-channel cognitive resource platform application of the user device;
receiving, at the entity intelligent platform application associated with the second networked device, a user device synchronize acknowledgment message comprising (i) a modified entity sequence number, and (ii) a user device sequence number, from the multi-channel cognitive resource platform application of the user device; and
transmitting, from the entity intelligent platform application associated with the second networked device, an entity synchronize acknowledgment message comprising a modified user device sequence number to the multi-channel cognitive resource platform application of the user device.

7. The system of claim 1, wherein the second networked device associated with the first entity comprises a beacon transmitter device.

8. The system of claim 1, wherein causing the second networked device to scan the vicinity radius around the first networked device further comprises:
activating a plurality of transmitter devices proximate the first networked device associated with the first entity;
causing each of the plurality of transmitter devices to transmit a signal to scan for devices having the multi-channel cognitive resource platform application, wherein the signal comprises one or more signal characteristics such that only the multi-channel cognitive resource platform application is structured to read the signal and transmit a unique response upon receiving the signal structured to be traced to an associated first transmitter device of the plurality of transmitter devices;
identifying, via the first transmitter device of the plurality of transmitter devices, the multi-channel cognitive resource platform application on the user device; and
disabling the plurality of transmitter devices associated with the first entity.

9. A method for adaptive dynamic multi-directional resource transmissions, wherein the method is structured for dynamically authenticating an activity between network devices based on establishing seamless electronic communication handshake between network devices, and deploying adapted mitigation resources, without requiring discontinuation of the activity, the method comprising:
receiving, from a first networked device associated with a first entity, resource activity processing data associated with a first activity initiated at the first networked device by a user;
analyzing the resource activity processing data to determine a first resource quantity to be transmitted in a first transmission direction from a first resource associated with a user device to an entity resource associated with the first entity for processing the first activity;
determining a first resource deficiency associated with the first resource such that the first resource deficiency prevents the first resource quantity to be transmitted in the first transmission direction from the first resource;
determining one or more adapted mitigation resources that are structured for augmenting the first resource, such that the augmented first resource is structured for transmitting the first resource quantity in the first transmission direction from the augmented first resource;
transmitting a control signal to a second networked device associated with the first entity, wherein the control signal is structured to cause the second networked device to scan a vicinity radius around the first networked device to identify devices having a multi-channel cognitive resource platform application;
authenticating the user device for the first activity, comprising:
establishing an operative communication link between the second networked device and the user device, wherein establishing the operative communication link comprises establishing a handshake between an entity intelligent platform application associated with the second networked device and the multi-channel cognitive resource platform application of the user device;
constructing a first device code associated with authenticating the first activity;
transmitting the constructed first device code to the user device;
identifying a code match, at the entity intelligent platform application of the second networked device, between a transformed first device code output by the user device and the constructed first device code; and
authenticating the first activity based on the identified code match;
automatically activating a display device of the user device and initiate presentation of a first interface associated with the one or more adapted mitigation resources;
in response to receiving a user input via the first interface of the display device of the user device, structuring a first adapted mitigation resource of the one or more adapted mitigation resources such that the first adapted mitigation resource comprises a first directional trigger token structured to automatically trigger transmission of the first resource quantity from the first resource to the entity resource upon receipt at the first resource;
transmitting a first adapted mitigation resource of the one or more adapted mitigation resources to the first resource in second transmission direction;
triggering, via the first directional trigger token, transmission of the first resource quantity from the first resource to the entity resource associated with the first entity in the first transmission direction;
processing the resource activity processing data for completing the first activity; and
transmitting a notification to the first networked device indicating the completion of the first activity.

10. The method of claim 9, wherein the first directional trigger token is structured to (i) prevent transmission of a second resource quantity different from the first resource quantity from the first resource, and (ii) prevent transmission from the first resource to a second resource different from the entity resource.

11. The method of claim 9, wherein the method further comprises:
analyzing resource data associated with a resource utilization data associated with the first resource, wherein the resource utilization data comprises temporal resource quantity levels, future resource transmission to the first resource in the second transmission direction; and
constructing the one or more adapted mitigation resources based on the resource utilization data.

12. The method of claim 9, wherein the first directional trigger token is structured to automatically pre-stage the first interface of the display device of the user device for the transmission of the first resource quantity from the first resource to the entity resource at the user, wherein automatically activating the display device of the user device further comprises preventing display of a second interface until receipt of the user input at the first interface of the display device of the user device, wherein the method further comprises receiving confirmation from the user for the transmission of the first resource quantity from the first resource to the entity resource at the user.

13. The method of claim 9,
wherein transmitted first device code is structured to cause the multi-channel cognitive resource platform application of the user device to:
transform the first device code into a format compatible with the operative communication link with the second networked device; and
output the transformed first device code to the entity intelligent platform application of the second networked device via the operative communication link.

14. The method of claim 9, wherein the second networked device associated with the first entity comprises a beacon transmitter device.

15. The method of claim 9, wherein causing the second networked device to scan the vicinity radius around the first networked device further comprises:
activating a plurality of transmitter devices proximate the first networked device associated with the first entity;
causing each of the plurality of transmitter devices to transmit a signal to scan for devices having the multi-channel cognitive resource platform application, wherein the signal comprises one or more signal characteristics such that only the multi-channel cognitive resource platform application is structured to read the signal and transmit a unique response upon receiving the signal structured to be traced to an associated first transmitter device of the plurality of transmitter devices;
identifying, via the first transmitter device of the plurality of transmitter devices, the multi-channel cognitive resource platform application on the user device; and
disabling the plurality of transmitter devices associated with the first entity.

16. A computer program product for adaptive dynamic multi-directional resource transmissions, wherein the computer program product is structured for dynamically authenticating an activity between network devices based on establishing seamless electronic communication handshake between network devices, and deploying adapted mitigation resources, without requiring discontinuation of the activity, wherein the computer program product comprises a non-transitory computer-readable medium comprising code that when executed causes a first apparatus to:
receive, from a first networked device associated with a first entity, resource activity processing data associated with a first activity initiated at the first networked device by a user;
analyze the resource activity processing data to determine a first resource quantity to be transmitted in a first transmission direction from a first resource associated with a user device to an entity resource associated with the first entity for processing the first activity;
determine a first resource deficiency associated with the first resource such that the first resource deficiency prevents the first resource quantity to be transmitted in the first transmission direction from the first resource;
determine one or more adapted mitigation resources that are structured for augmenting the first resource, such that the augmented first resource is structured for transmitting the first resource quantity in the first transmission direction from the augmented first resource;
transmit a control signal to a second networked device associated with the first entity, wherein the control signal is structured to cause the second networked device to scan a vicinity radius around the first networked device to identify devices having a multi-channel cognitive resource platform application;
authenticating the user device for the first activity, comprising:
establishing an operative communication link between the second networked device and the user device, wherein establishing the operative communication link comprises establishing a handshake between an entity intelligent platform application associated with the second networked device and the multi-channel cognitive resource platform application of the user device;
constructing a first device code associated with authenticating the first activity;
transmitting the constructed first device code to the user device;
identifying a code match, at the entity intelligent platform application of the second networked device, between a transformed first device code output by the user device and the constructed first device code; and
authenticating the first activity based on the identified code match;
automatically activate a display device of the user device and initiate presentation of a first interface associated with the one or more adapted mitigation resources;
in response to receiving a user input via the first interface of the display device of the user device, structure a first adapted mitigation resource of the one or more adapted mitigation resources such that the first adapted mitigation resource comprises a first directional trigger token structured to automatically trigger transmission of the first resource quantity from the first resource to the entity resource upon receipt at the first resource;
transmit a first adapted mitigation resource of the one or more adapted mitigation resources to the first resource in second transmission direction;
trigger, via the first directional trigger token, transmission of the first resource quantity from the first resource to the entity resource associated with the first entity in the first transmission direction;
process the resource activity processing data for completing the first activity; and transmit a notification to the first networked device indicating the completion of the first activity.

17. The computer program product of claim 16, wherein the first directional trigger token is structured to (i) prevent transmission of a second resource quantity different from the first resource quantity from the first resource, and (ii) prevent transmission from the first resource to a second resource different from the entity resource.

18. The computer program product of claim 16, wherein the non-transitory computer-readable medium further comprises code that when executed causes the first apparatus to:
analyze resource data associated with a resource utilization data associated with the first resource, wherein the resource utilization data comprises temporal resource quantity levels, future resource transmission to the first resource in the second transmission direction; and
construct the one or more adapted mitigation resources based on the resource utilization data.

19. The computer program product of claim 16, wherein the first directional trigger token is structured to automatically pre-stage the first interface of the display device of the user device for the transmission of the first resource quantity from the first resource to the entity resource at the user, wherein automatically activating the display device of the user device further comprises preventing display of a second interface until receipt of the user input at the first interface of the display device of the user device, wherein the non-transitory computer-readable medium further comprises code that when executed causes the first apparatus to receive confirmation from the user for the transmission of the first resource quantity from the first resource to the entity resource at the user.

20. The computer program product of claim 16, wherein causing the second networked device to scan the vicinity radius around the first networked device further comprises:
activating a plurality of transmitter devices proximate the first networked device associated with the first entity;
causing each of the plurality of transmitter devices to transmit a signal to scan for devices having the multi-channel cognitive resource platform application, wherein the signal comprises one or more signal characteristics such that only the multi-channel cognitive resource platform application is structured to read the signal and transmit a unique response upon receiving the signal structured to be traced to an associated first transmitter device of the plurality of transmitter devices;
identifying, via the first transmitter device of the plurality of transmitter devices, the multi-channel cognitive resource platform application on the user device; and
disabling the plurality of transmitter devices associated with the first entity.
